(19) United States
(12) Patent Application Publication
(10) Pub. No.: US 2013/0181825 A1
(43) Pub. Date: Jul. 18, 2013

(54) Guardian Warning System

(71) Applicants: Jerry Johnson, Baker City, OR (US); Nadejda Ivanovna Johnson, Baker City, OR (US)

(72) Inventors: Jerry Johnson, Baker City, OR (US); Nadejda Ivanovna Johnson, Baker City, OR (US)

(21) Appl. No.: 13/350,733

(22) Filed: Jan. 13, 2012

(51) Int. Cl. B60Q 1/00

(52) U.S. Cl. 340/440

(57) ABSTRACT

A Guardian Warning System comprising a multi-axis accelerometer, a micro-controller, an audible alarm, a visual indication and a GPS chip.

The Guardian Warning System provide detection of the angle, degree or slop of ATV, UTV and any vehicle type or any other object where it needs to be detected.

The Guardian Warning System will sound an audible alarm and flash a LED light when said Degree, Angle or Slope is reached.

The said elements contained in a molded plastic container, which can be attached to ATVs, UTVs and any vehicle type or any other objects where the Degree, Angle or Slope needs to be detected.

### BACKGROUND

The invention relates generally to detection of Degree, Angle and Slope, more specifically, to a new apparatus for detecting the Degree, Angle or Slope when needed. The present invention is of particular use anywhere knowledge of Degree, Angle or Slope is needed. Knowledge of Degree, Angle or slope is critical when riding an ATV, UTV or a Riding lawn Mower.

The design uses an acceleration sensor to determine the static and dynamic acceleration forces applied to a vehicle. The raw sensor signals are passed through filtering function that averages/smoothes the signal over time to determine if the vehicle is approaching a critical limit in order to annunciate to the operator by way of audio and/or visual alarm indicators.

The acceleration sensor(s) used in the prototype is a solid state device that measures 3-axis acceleration (left/right, forward/backward, up/down).

The analog signal out of the accelerometer is digitized and all the filtering, averaging, and threshold detection is performed in software

### SUMMARY OF THE INVENTION

In view of the foregoing, it is the primary object of this invention to provide a warning system for use on ATVs, UTVs, Riding Lawn Mowers and/or any type of vehicle or object where the Degree, Angle or Slope needs to be known.

According to an embodiment of the invention, a warning system that comprises a molded plastic container for housing an Acceleration Sensor, a Processor and all electronic and mechanical parts necessary, to include an electronic GPS chip to provide data when a crash occurs.

The advantage of the present invention is the provision of a warning system that is useful particular while riding recreational vehicles, such as an ATVs, UTVs, RIDING LAWN MOWERS, etc.

Another advantage of the present invention, the Guardian Warning System can be mounted in all positions except upside down. Once mounted in any position, except upside down, a button can pushed and the warning system will read the vehicle as level when the vehicle or object is on a level surface.

A further advantage of the present invention is the ability to mount on any type of vehicle or object where the Degree, Angle or Slope needs to be known.

An important advantage of the present invention the Guardian Warning System will warn the user by an audible SOUND and a LED flashing light.

Another very important advantage of the present invention, the hearing impaired will have a very bright flashing LED light.

### DESCRIPTION OF PREFERRED EMBODIMENTS

The Guardian Warning System comprising: a Triple Axis analog accelerometer MMA 7361, a microcontroller AT Mega 328, GPS Chip/Smart Card, Light-emitting diode (LED), Switch and Audible Alarm.

All said elements contained in a molded plastic container. Said container can be attached to an ATV, UTV or any vehicle type or any object where the Degree, Angle or Slope needs to be detected.

Accelerometer MMA 7361 determines the static and dynamic acceleration forces applied to a vehicle or object.

Microcontroller AT Mega 328 receives the analog signal out of said Accelerometer is digitized and all filtering, averaging, and threshold detection is performed in software.

GPS Chip/ Smart Card stores useful digital information, that can be downloaded to determine the facts relating to an ATV or any vehicle crash using The Guardian. The downloaded information will provide mayor parameters, such as speed, degree of angle, time and date the crash occurred.

### DESCRIPTION OF THE DRAWINGS

Foregoing and other objects, features, and advantages of the present invention will be apparent from the following more particular description of preferred embodiments as illustrated in the accompanying drawings. The drawings are not necessarily to scale, emphasis instead being placed upon illustrating the principles and usefulness of the invention.

FIG. 1 shows System Description, movement and orientation detection device with operator notification, and block diagram of system.

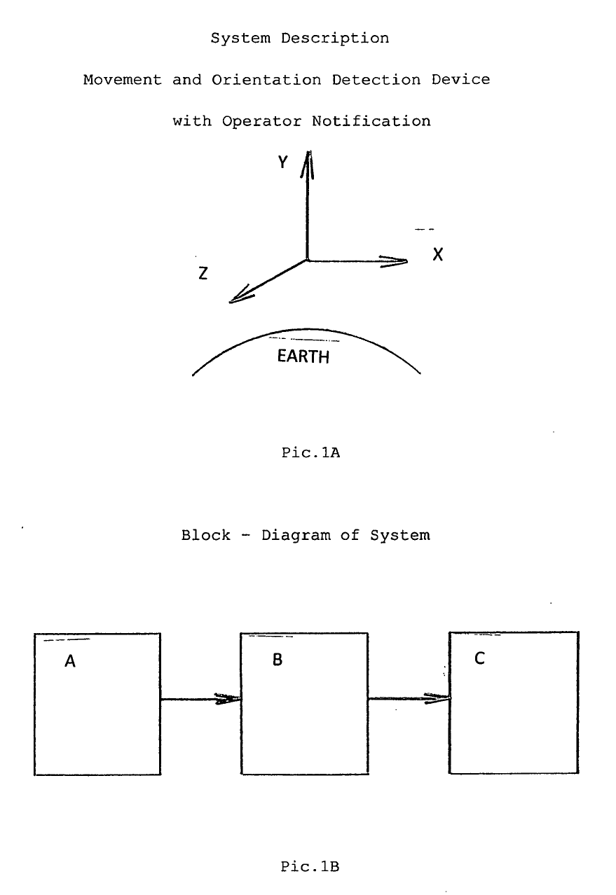

FIG. 2 shows The Guardian Warning System Schematic, where all elements and connections between elements of the System explain the working process.

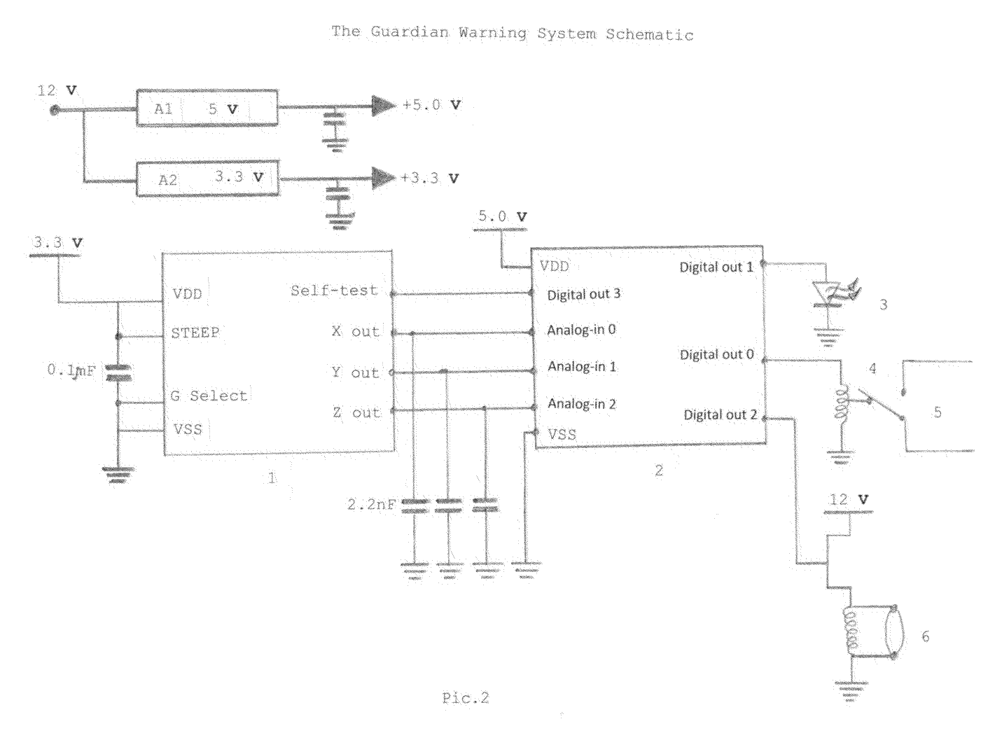

1. The Guardian Warning System comprising a multi-axis accelerometer, a micro-controller, GPS Chip, an audible alarm and a visual indication.

2. The Guardian Warning System of claim 1 wherein it can be installed in a vehicle to measure the slope or angle of the terrain said vehicle is traversing.

3. The Guardian Warning System of claim 1 wherein it can measure a vehicle's dynamic accelerations.

4. The Guardian Warning System of claim 1 wherein exceeding thresholds of acceleration or terrain slope produces an alarm condition.

5. The Guardian Warning System of claim 1 wherein the acceleration signals from the accelerometer are digitized.

6. The Guardian Warning System of claim 1 wherein the digitized acceleration signals are processed by a micro-controller.

7. The Guardian Warning System of claim 1 wherein the micro-controller generates the signal to activate an audible alarm and visual indication.

8. A method comprising digital signal processing and filtering of the digitized acceleration signals, calculating the resultant acceleration vectors and applying threshold detection to the acceleration vectors to assert an alarm indication.

9. The method of claim 8 further comprising calculating a moving average and smoothing functions to remove instantaneous measurement errors.

10. The method of claim 8 further comprising vector translation to remove installation and static measurement error.

11. The method of claim 9 further comprising a learning period to measure the installation and measurement error.
